(19) United States
(12) Patent Application Publication
(10) Pub. No.: US 2013/0301303 A1
(43) Pub. Date: Nov. 14, 2013

(54) POWER CONTROLLERS AND CONTROL METHODS

(71) Applicant: LEADTREND TECHNOLOGY CORP., Hsin-Chu (TW)

(72) Inventors: Yi-Lun Shen, Hsin-Chu (TW); Yu-Yun Huang, Hsin-Chu (TW)

(73) Assignee: Leadtrend Technology Corp., Hsin-Chu (TW)

(21) Appl. No.: 13/798,199

(22) Filed: Mar. 13, 2013

(30) Foreign Application Priority Data
May 11, 2012 (TW) 101116752

(51) Int. Cl. H02M 3/24

(52) U.S. Cl. CPC H02M 3/24
USPC 363/15

(57) ABSTRACT

Disclosed include power controllers and related control methods. A disclosed power controller has a pulse generator, a sample/hold device, a comparator, and a switch controller. The pulse generator provides an enable signal, defining an enable time. The comparator has two inputs capable of being coupled to a reference signal and a feedback signal, respectively, and an output coupled to a compensation capacitor. When enabled by the enable signal, the comparator charges/discharges the compensation capacitor. The switch controller controls a power switch according to a compensation voltage of the compensation capacitor. A feedback voltage of the feedback signal is able to correspond to an output voltage of the power supply.

### BACKGROUND OF THE INVENTION

1. Field of the Invention

The present invention relates to a power controller and a control method applied to a switching-mode power supply, and particularly to a power controller and a control method applied to a switching-mode power supply that can reduce cost of the switching-mode power supply.

2. Description of the Prior Art

A power supply which is an essential device in most of electronic products is used for converting power generated by a battery or an alternating current (AC) into power with a predetermined specification required by the electronic products. In various power supplies, because a switching-mode power supply has superior power conversion efficiency and small volume, it is widely popular by the power industries.

It is well-known for those skilled in the art that the switching-mode power supply has two different control methods: a primary side control (PSC) method and a secondary side control (SSC) method. In the SSC method, an output terminal of a secondary winding of a power supply is directly coupled to a detection circuit. Then, the detection circuit transmits a detection result to a power controller of a primary side of the power supply through a photo coupler to control power stored and converted in a primary winding of the power supply. Compared to the SSC method, the PSC method indirectly detects a voltage outputted by the secondary winding, and also indirectly detects an output voltage of the output terminal of the power supply through directly detecting an induced voltage of an auxiliary winding. Compared to the SSC method, detection and control of power conversion of the PSC method is implemented in the primary side, the PSC method may reduce cost of the power supply because the power supply does not need photo coupler which has large volume and high cost. In addition, because the PSC method does not have a detection circuit which can consume fixed power in a secondary side, the PSC method can have higher power conversion efficiency.

FIG. 1 is a diagram illustrating a switching-mode power supply adopting the PSC method according to the prior art . A bridge rectifier 20 can convert an alternative current generated from an alternative current line AC into a direct current input power V_{IN}. A voltage of the input power V_{IN} may have an M-shape waveform, or may also be filtered to a fixed value not varied with time. A power controller 26 periodically controls a power switch 34 through a driving terminal GATE. When the power switch 34 is turned on, a primary winding PRM stores power; and when the power switch 34 is turned off, a secondary winding SEC and an auxiliary winding AUX release power to establish an output power V_{OUT} to a load 24 and operation power V_{CC} to the power controller 26, respectively.

Divider resisters 28 and 30 detect a voltage V_{AUX} of the auxiliary winding AUX to provide a feedback signal V_{FB} to a feedback terminal FB of the power controller 26. The power controller 26 establishes a compensation voltage V_{COM} on a compensation capacitor 32 according to the feedback signal V_{FB}, and controls the power switch 34 according to the compensation voltage V_{COM}.

FIG. 2 is a diagram illustrating the power controller 26 and some external devices in FIG. 1. The power controller 26 includes a sampler 12, a pulse generator 14, a comparator 15, and a pulse width controller 16. FIG. 3 is a timing diagram illustrating signals in FIG. 1 and FIG. 2, where a driving signal V_{GATE} of a driving terminal GATE, the feedback signal V_{FB} of the feedback terminal FB, a sample clock signal V_{SH} provided to the sampler 12 by the pulse generator 14, a sample signal V_{IFB} generated by the sampler 12, and the compensation voltage V_{COM} generated on the compensation capacitor 32 by the comparator 15 are listed from top to down.

### SUMMARY OF THE INVENTION

An embodiment provides a control method applied to a power supply. The power supply includes a power switch. The control method includes providing an enable time after the power switch is turned off; charging/discharging a compensation capacitor according to a feedback signal and a reference signal during the enable time; and controlling the power switch according to a compensation voltage of the compensation capacitor. A feedback voltage of the feedback signal roughly corresponds to an output voltage of the power supply.

Another embodiment provides a power controller. The power controller includes a pulse generator, a sampler, a comparator, and a switch controller. The pulse generator provides an enable signal and defines an enable time. The comparator has two inputs is capable of being coupled to a feedback signal and a reference signal, and an output coupled to a compensation capacitor. The comparator is enabled by the enable signal to charge/discharge the compensation capacitor. The switch controller controls a power switch according to a compensation voltage of the compensation capacitor. A feedback voltage of the feedback signal roughly corresponds to an output voltage of a power supply.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a switching-mode power supply adopting the PSC method according to the prior art.

FIG. 2 is a diagram illustrating the power controller and some external devices in FIG. 1.

FIG. 3 is a timing diagram illustrating signals in FIG. 1 and FIG. 2.

FIG. 4 is a diagram illustrating a power supply according to an embodiment.

FIG. 5 is a diagram illustrating the power controller and some external devices in FIG. 4.

FIG. 6 is a timing diagram illustrating signals in FIG. 4 and FIG. 5

FIG. 7 is a diagram illustrating the power controller and some external devices according to another embodiment

FIG. 8 is a timing diagram illustrating signals in FIG. 7.

### DETAILED DESCRIPTION

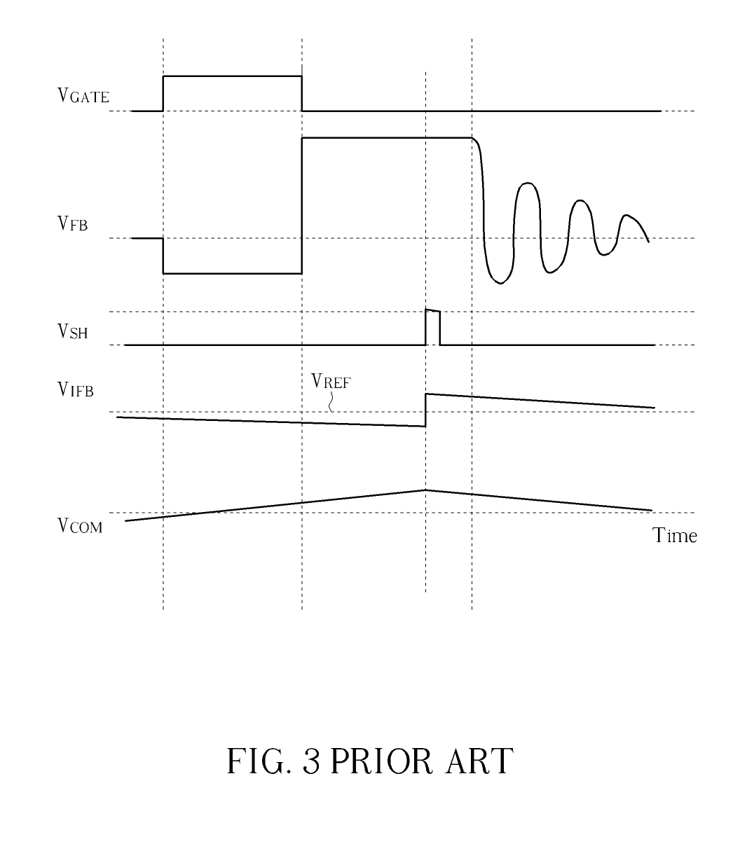

As shown in FIG. 3, the sample signal V_{IFB} generated by the sampler 12 sampling the feedback signal V_{FB} represents a feedback signal V_{FB} during a predetermined time of a discharge time T_{DIS}, and the sample signal V_{IFB} can correspond to the output power V_{OUT} of the secondary side. Therefore, the sample signal V_{IFB} should be maintained at a sampled result. However, the sample signal V_{IFB} may be increased or decreased gradually due to leakage. As shown in FIG. 3, the sample signal V_{IFB} is decreased with time except the sampling time. Therefore, in most of time, the sample signal V_{IFB} can not accurately represent the feedback signal V_{FB} of the predetermined time. Thus, because the comparator 15 charges/discharges the compensation capacitor 32 according to the wrong sample signal V_{IFB}, the comparator 15 may establish the wrong compensation voltage V_{COM} (as shown in FIG. 3), resulting in the wrong output voltage being on the output power V_{OUT}.

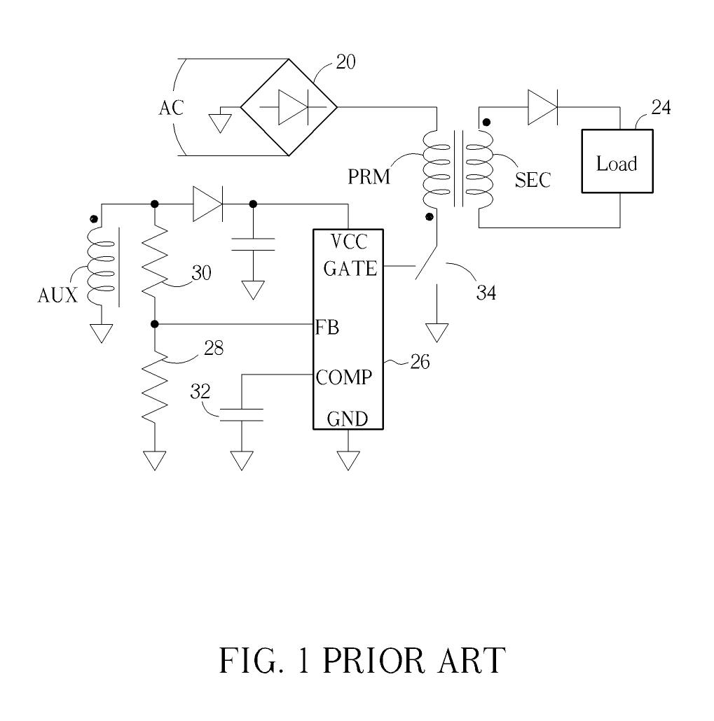

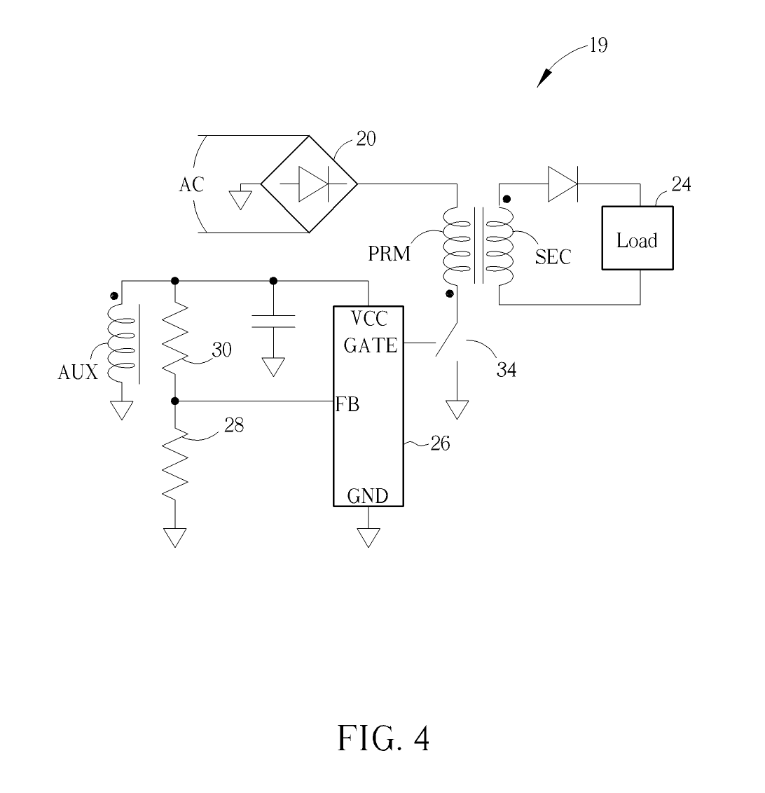

FIG. 4 is a diagram illustrating a power supply 19 according to an embodiment. A power controller 60 of the power supply 19 can be a monolithic integrated circuit. Compared to the prior art in FIG. 1, the power supply 19 does not have the external compensation capacitor 32, so the power supply 19 may save bill of material (BOM) cost from the view of system cost. It is described later that the power supply 19 can not have the external compensation capacitor 32.

In another embodiment of the present invention, the power supply 19 can have the external compensation capacitor 32 like the power supply in FIG. 1.

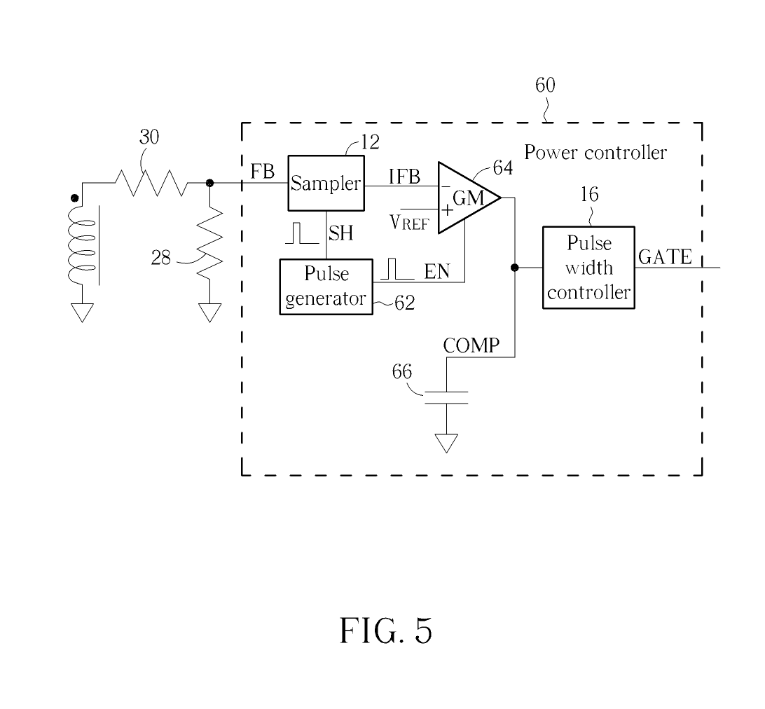

FIG. 5 is a diagram illustrating the power controller 60 and some external devices in FIG. 4. The power controller 60 includes the sampler 12, a pulse generator 62, a comparator 64, and the pulse width controller 16.

The pulse generator 62 provides a sample clock signal V_{SH} and an enable signal V_{EN} to the sampler 12 and the comparator 64, respectively.

The sample clock signal V_{SH} can define a sample time T_{SH} for the sampler 12 sampling the feedback signal V_{FB}. When the sample clock signal V_{SH} is asserted, the sample signal V_{IFB} is equal to the feedback signal V_{FB}; when the sample clock signal V_{SH} is deasserted, the sample signal V_{IFB} should be maintained and isolated from the feedback signal V_{FB}.

The enable signal V_{EN} can define an enable time T_{EN} for the comparator 64 driving the compensation capacitor 66. In one embodiment, the comparator 64 is a transconductor having two inputs coupled to the sample signal V_{IFB} and a reference signal V_{REF}, respectively, and an output coupled to the compensation capacitor 66. When the enable signal V_{EN} is asserted, the comparator 64 charges/discharges the compensation capacitor 66 according to a difference between the sample signal V_{IFB} and the reference signal V_{REF}; when the enable signal V_{EN} is deasserted, the output of the comparator 64 has high impedance, so the compensation capacitor 66 can maintain the compensation voltage V_{COM}.

The pulse width controller 16 drives a driving terminal GATE according to the compensation voltage V_{COM}. In one embodiment, the pulse width controller 16 controls turning-on time T_{ON} of a power switch 34 according to the compensation voltage V_{COM}. In another embodiment, the compensation voltage V_{COM} determines a switching frequency of the power switch 34.

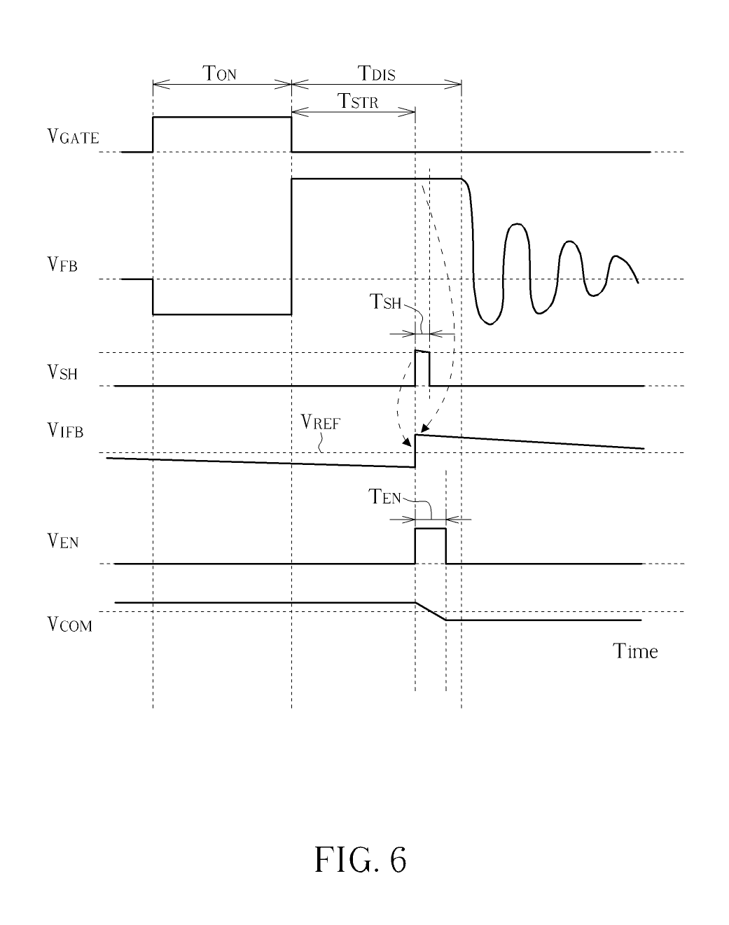

FIG. 6 is a timing diagram illustrating signals in FIG. 4 and FIG. 5, where a driving signal V_{GATE}, the feedback signal V_{FB}, the sample clock signal V_{SH}, the sample signal V_{IFB}, the enable signal V_{EN}, and the compensation voltage V_{COM} are listed from top to down. During the turning-on time T_{ON}, the driving signal V_{GATE} is asserted and the feedback signal V_{FB} corresponds to a negative voltage induced by the auxiliary winding AUX.

After the driving signal V_{GATE} is changed from being asserted to being deasserted, the driving signal V_{GATE} enters turning-off time T_{OFF}. A beginning part of the turning-off time T_{OFF} is a discharge time T_{DIS}. During the discharge time T_{DIS}, at first, the feedback signal V_{FB} is raised to a high level corresponding to the output voltage of the secondary side. When the discharge time T_{DIS} is completed, because the secondary winding SEC finishes discharging, the feedback signal V_{FB} is fallen to cross 0V. In one embodiment, the discharge time T-_{DIS} is defined as time for the secondary winding SEC continuously discharging to the output terminal OUT. In another embodiment, the discharge time T_{DIS} is defined as time for the feedback signal V_{FB} being roughly higher than 0V.

In one embodiment, the pulse generator 62 determines a waiting time T_{STR} according to a discharge time T_{DIS} of a previous switch period, that is, the pulse generator 62 determines a beginning of the sample time T_{SH} according to the discharge time T_{DIS} of the previous switch period. Fro example, the waiting time T_{STR} is two-thirds of the discharge time T_{DIS} of the previous switch period. In another embodiment, the waiting time T_{STR} can be a fixed value.

As shown in FIG. 6, the sample signal V_{IFB} is decreased gradually due to leakage before the sample time T_{SH}. However, during the sample time T_{SH}, the sample signal V_{IFB} is refreshed to accurately correspond to the feedback signal V_{FB} (corresponding to a voltage of the output power V_{OUT}) at the time. After the sample time T_{SH}, the sample signal V_{IFB} is still decreased with time. That is to say, during the sample time T_{SH} and a transient time after the sample time T_{SH}, the sample signal V_{IFB} can substantially correspond to the voltage of the output power V_{OUT}.

In FIG. 6, the enable signal V_{EN} and the sample clock signal V_{SH} are roughly asserted simultaneously, and an interval of the enable time T_{EN} is slightly longer than an interval of the sample time T_{SH}. As shown in FIG. 6, during the enable time T_{EN}, because the sample signal V_{IFB} is higher than the reference signal V_{REF}, the compensation capacitor 66 is discharged by the comparator 64, resulting in the compensation voltage V_{COM} being decreased. The discharge process can be terminate with the enable time T_{EN} passing, so the compensation capacitor 66 can maintain the compensation voltage V_{COM}. Meanwhile, if the sample signal V_{IFB} is wrong due to leakage, the compensation voltage V_{COM} can not be influenced. As the above mentioned, during the enable time T_{EN}, the sample signal V_{IFB} substantially corresponds to the voltage of the output power V_{OUT} at the time, so the compensation voltage V_{COM} can be more correct. The established voltage of the output power V_{OUT} can also be more correct.

Because the enable time T_{EN} can be very short, a capacitance of the compensation capacitor 66 does not have to be large to satisfy frequency compensation of an entire control loop. Therefore, in one embodiment, compensation capacitor 66 is composed of a capacitor within an integrated circuit, and the power controller 60 does not need to provide a pin to connect an external compensation capacitor. However, in another embodiment, the power controller 60 can also provide a pin to connect an external compensation capacitor to increase a capacitance of the compensation capacitor.

In one embodiment, the sample clock signal V_{SH} and the enable signal V_{EN} are the same signal, so the sample time T_{SH} is equal to the enable time T_{EN}.

In another embodiment, the enable time T_{EN} is within the sample time T_{SH} and is shorter than the sample time T_{SH}.

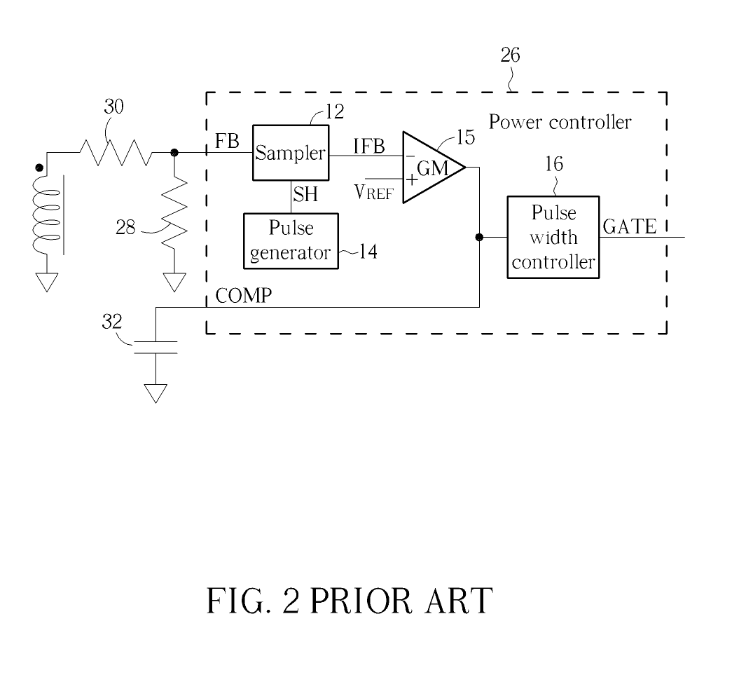

Compared to the power controller 26 in FIG. 2, at least, the power controller 60 has advantages as follows: first, because the compensation voltage V_{COM} is only influenced by the roughly correct sample signal V_{IFB}, the voltage of the output power V_{OUT} can be more correct; second, because the external compensation capacitor is neglected, bill of material (BOM) cost of the power controller 60 can be cheaper.

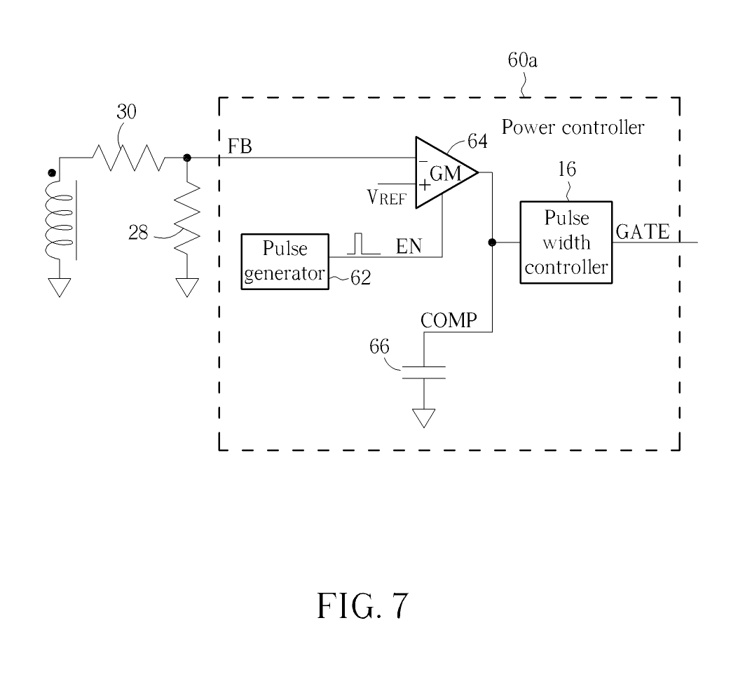

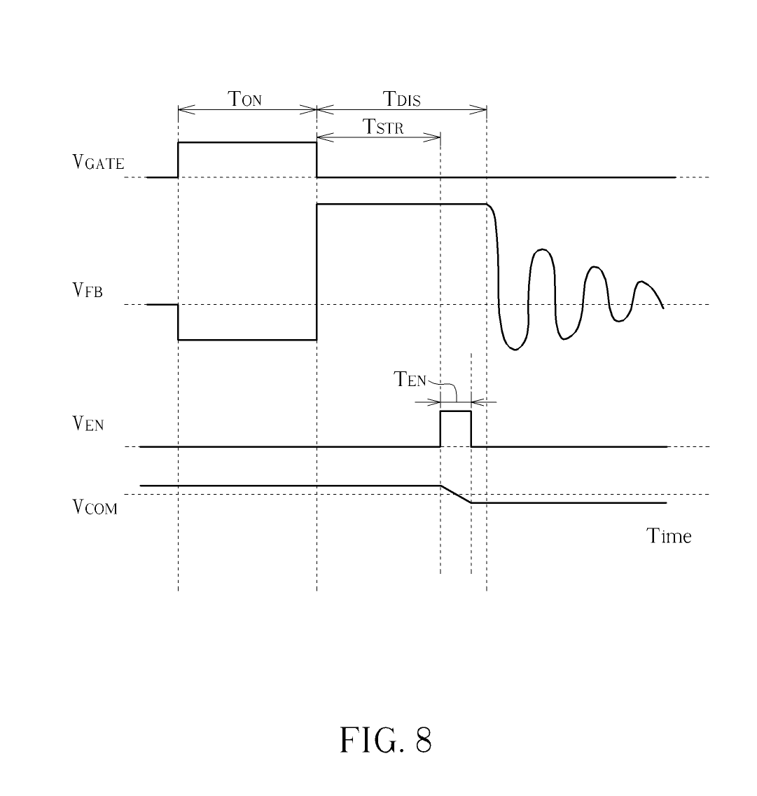

FIG. 7 is a diagram illustrating the power controller 60a and some external devices according to another embodiment, where the power controller 60a can substitute for the power controller 60 in FIG. 4 and FIG. 5. FIG. 8 is a timing diagram illustrating signals in FIG. 7.

A difference between the power controller 60 in FIG. 5 and the power controller 60a is that the power controller 60a does not have the sampler 12. Therefore, compared to the power controller 60 in FIG. 5, a pulse generator 62a of the power controller 60a only generates the enable signal V_{EN} to control time for the comparator 64 charging/discharging the compensation capacitor 66. As shown in FIG. 7, the two input of the comparator 64 are directly coupled to the feedback signal V_{FB} and the reference signal V_{REF}, respectively.

As shown in FIG. 8, the enable time T_{EN} defined by the enable signal V_{EN} is within the discharge time T_{DIS} and is shorter than the discharge time T_{DIS}. Thus, during the enable time T_{EN}, the feedback signal V_{FB} can substantially correspond to the voltage of the output power V_{OUT} at the time, so the pulse width controller 16 can control turning-on/turning-off of the power switch 34 through the driving terminal GATE according to a comparison result of the comparator 64 to make the power supply 19 increase or decrease output power, resulting in the adjusted compensation voltage V_{COM} being more correct . Therefore, the established voltage of the output power V_{OUT} is also more correct.

The power controller 60a in FIG. 7 similar to the power controller 60 in FIG. 5 still has advantages as follows: the voltage of the output power V_{OUT} can be more correct; and bill of material (BOM) cost of the power controller 60a can be cheaper.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control method applied to a power supply, the power supply comprising a power switch, the control method comprising:
providing an enable time after the power switch is turned off;
charging/discharging a compensation capacitor according to a feedback signal and a reference signal during the enable time; and
controlling the power switch according to a compensation voltage of the compensation capacitor;
wherein a feedback voltage of the feedback signal roughly corresponds to an output voltage of the power supply.

2. The control method of claim 1, further comprising:
providing a sample time after the power switch is turned off;
sampling the feedback signal to generate a sample signal during the sample time; and
charging/discharging the compensation capacitor according to the sample signal and the reference signal during the enable time.

3. The control method of claim 2, wherein a beginning of the enable time is roughly the same as a beginning of the sample time.

4. The control method of claim 2, wherein an interval of the enable time is not shorter than an interval of the sample time.

5. The control method of claim 1, wherein controlling the power switch is controlling turning-on time of the power switch.

6. The control method of claim 1, wherein the feedback voltage of the feedback signal roughly corresponds to the output voltage of the power supply during the enable time.

7. The control method of claim 1, wherein a beginning of the enable time is generated according to a discharge time of a previous switch period.

8. The control method of claim 1, wherein a switch period of the power supply has a discharge time, and the enable time is shorter than the discharge time.

9. A power controller, comprising:
a pulse generator for providing an enable signal, and defining an enable time;
a comparator having two inputs capable of being coupled to a feedback signal and a reference signal, and an output coupled to a compensation capacitor, wherein the comparator charges/discharges the compensation capacitor when the comparator is enabled by the enable signal; and
a switch controller for controlling a power switch according to a compensation voltage of the compensation capacitor;
wherein a feedback voltage of the feedback signal roughly corresponds to an output voltage of a power supply.

10. The power controller of the claim 9, wherein the pulse generator further provides a sample clock signal and defines a sample time, and the power controller further comprises:
a sampler for sampling the feedback signal to generate a sample signal according to the sample clock signal;
wherein one of the two inputs of the comparator is coupled to the sample signal.

11. The power controller of the claim 10, wherein the sample time corresponds to the enable time.

12. The power controller of the claim 10, wherein a beginning of the enable time is roughly the same as a beginning of the sample time.

13. The power controller of the claim 9, wherein the switch controller controls a turning-on time of the power switch.

14. The power controller of the claim 9, wherein a beginning of the enable time is generated according to a discharge time of a previous switch period.

15. The power controller of the claim 9, wherein the enable time is shorter than a discharge time of a switch period.
